(19) United States
(12) Patent Application Publication
(10) Pub. No.: US 2007/0081297 A1
(43) Pub. Date: Apr. 12, 2007

(54) Method of manufacturing thin film capacitor and printed circuit board having thin film capacitor embedded therein

(75) Inventors: Min Ji Ko, Suwon (KR); Yul Kyo Chung, Yongin (KR); Eun Tae Park, Yongin (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/541,676

(22) Filed: Oct. 3, 2006

(30) Foreign Application Priority Data
Oct. 12, 2005 (KR) 10-2005-0095957

(51) Int. Cl. H01G 4/06

(52) U.S. Cl. 361/311

(57) ABSTRACT

A method of manufacturing a thin film capacitor includes steps of: performing recrystallization heat treatment on a metal foil; forming a dielectric layer on a top surface of the recrystallized metal foil; heat treating the metal foil and the dielectric layer; and forming an upper electrode on a top surface of the heat-treated dielectric layer. The recrystallization heat treatment prevents the oxidation of a metal foil, by which a dielectric layer can be heat treated at a high temperature, thereby improving electric properties of a thin film capacitor and the reliability of a product.

### CLAIM OF PRIORITY

This application claims the benefit of Korean Patent Application No. 2005-95957 filed on Oct. 12, 2005, in the Korean Intellectual Property Office, the disclosure of which is incorporated herein by reference.

### BACKGROUND OF THE INVENTION

### CROSS REFERENCE OF PRIOR ART

U.S. Pat. No. 5,079,069

U.S. Pat. No. 5,261,153

U.S. Pat. No. 5,800,575

US Patent Application Publication No. 2005/0011857

U.S. Pat. No. 6,841,080

US Patent Application Publication No. 2003/0207150

US Patent Application Publication No. 2002/0195612

1. Field of the Invention

The present invention relates to a method of manufacturing a thin film capacitor and a printed circuit board (PCB) having the thin film capacitor embedded therein, which is manufactured by the same method. More particularly, the invention relates to a method of manufacturing a thin film capacitor, which is improved in capacitance characteristics and breakdown voltage (BDV) characteristics, and a PCB with the thin film capacitor embedded therein.

2. Description of the Related Art

Various passive devices mounted on a PCB are becoming an obstacle to the miniaturization of products. In particular, as more semiconductor active elements are provided as built-in or embedded parts and their input/output terminals are increasing in number, it is required to secure more spaces for passive elements around the active elements.

A representative passive element is capacitor, which is placed most adjacent to an input terminal to reduce inductance as higher operating frequencies are used.

To meet such miniaturization and high frequency demands, active researches are being carried out to realize an embedded capacitor. The embedded capacitor is provided as embedded in a PCT, remarkably reducing product size. In addition, the embedded capacitor can be placed very close to an input terminal of an active element to minimize line length thereby reducing inductance by a large level while easily reducing high frequency noises.

Representative examples of the embedded capacitor are disclosed in U.S. Pat. Nos. 5,079,069, 5,261,153 and 5,800,575. These patents are approaches proposed by Sanmina (assigned to Zycon Corporation) of the United States, in which a dielectric layer having capacitor characteristics is inserted or embedded into an inner layer of a PCB to obtain a capacitor. In these documents, it is reported that the dielectric layer characteristics can be obtained even from a PCB material known as FR4. Furthermore, to obtain a desired amount of capacitance, the dielectric layer can adopt an epoxy polymer (i.e., polymer-ceramic composite) where a ferroelectric powder of high dielectric constant is dispersed.

However, the polymer-ceramic composite shows limited capacitance when used as the dielectric layer and thus any capacitor made therefrom cannot be embedded in a small sized product in the package level. Accordingly, to produce embedded decoupling capacitors which are mainly demanded in the electronics industry, various thin film technologies are necessary to improve the dielectric constant of the dielectric layer and reduce the thickness of the same.

A technology of using ceramics in place of a polymer-ceramic composite for dielectric layers of an embedded thin film capacitor is proposed in US Patent Application Publication 2005/0011857. This technology includes steps of forming a ceramic dielectric layer on an untreated metal foil, annealing at a temperature in the range from 800° C. to 1050° C., and re-oxidizing resultant dielectric material so as to form a conductive layer.

According to this technology, since the untreated metal foil is annealed together with the dielectric layer at a high temperature, capacitance drops owing to the oxidation of the metal foil. Furthermore, there is a drawback in that the metal foil induces stress to the dielectric layer, which causes defects in the interface between the metal foil and dielectric layer, thereby deteriorating BDV characteristics.

To prevent the oxidation of a metal foil during heat treatment, a method of forming a barrier layer of for example Ni between the metal foil and a dielectric layer is disclosed in U.S. Pat. No. 6,841,080. In addition, US Patent Application Publication No. 2003/0207150 discloses a method of controlling oxygen partial pressure during the annealing of a dielectric layer. These methods can prevent the oxidation of the metal foil to a specific degree.

In the meantime, US Patent Application Publication No. 2002/0195612 proposes a method of pre-annealing a Ni-coated copper Cu substrate in an anaerobic atmosphere, at a temperature higher than the annealing temperature (from 500° C. to 600° C.) of a dielectric layer. According to this method, the pre-annealing is carried out via heat treatment at a temperature ranging from 400° C. to 820° C. for a sufficient time in order to prevent the migration of copper ions into the dielectric layer during the annealing of the metal foil and the dielectric layer. The nickel film functioning as the barrier layer has a thickness on the order of 0.1 μgm to 2.0 μm.

However, although the pre-annealing is carried out in an anaerobic atmosphere, there is a problem in that copper is gradually oxidized, resulting in rapid deterioration of capacitance.

### SUMMARY OF THE INVENTION

The present invention has been made to solve the foregoing problems of the prior art and therefore an object of certain embodiments of the present invention is to provide a method of manufacturing a thin film capacitor, which can prevent the oxidation of a lower electrode of the thin film capacitor as well as defects in the interface between the lower electrode and a dielectric layer in order to secure BDV characteristics, and a PCB having the thin film capacitor embedded therein.

According to an aspect of the invention for realizing the object, there is provided a method of manufacturing a thin film capacitor. This method includes steps of: performing recrystallization heat treatment on a metal foil; forming a dielectric layer on a top surface of the recrystallized metal foil; heat treating the metal foil and the dielectric layer; and forming an upper electrode on a top surface of the heat-treated dielectric layer.

The invention recrystallizes the metal coil via heat treatment beforehand in order to prevent any defects in the interface between the metal foil and dielectric layer during the subsequent heat treatment.

According to the invention, the recrystallization heat treatment of the metal foil can be performed at a relatively lower temperature for a short time period since this process is to recrystallize the metal foil. Since this process is performed at a relatively lower temperature for a short time period, it does not cause the oxidation of the metal foil even if performed in an ambient atmosphere.

The recrystallization heat treatment of the metal foil is performed preferably at a temperature in the range from 100° C. to 450° C. At a relatively higher temperature such as from 400° C. to 450° C., the recrystallization heat treatment is performed preferably for a short time period. When performed for a long time period, it may result in capacitance decrease.

The invention can be modified into various forms based on the principle as defined by the appended claims, of which most preferable embodiments are as follows.

As an embodiment, the method includes steps of: performing recrystallization heat treatment on a metal foil at a temperature ranging from 100° C. to 450° C. for 5 mins to 30 mins; forming a dielectric layer on a top surface of the recrystallized metal foil; heat treating the metal foil and the dielectric layer; and forming an upper electrode on a top surface of the heat-treated dielectric layer.

In the invention, the recrystallization heat treatment may be performed in any atmosphere which is not specifically controlled. Preferably, the recrystallization heat treatment may be performed in an ambient atmosphere.

Preferably, the metal foil is one selected from Cu and Cu alloys.

A barrier layer is additionally formed on a top surface of the metal foil # [symbol] before the recrystallization heat treatment. Preferably, the barrier layer is made of Ni.

In the invention, the dielectric layer may comprise a ferroelectric material, whose examples include PZT and PLZT.

In the invention, the upper electrode may comprise a conductive metal, whose examples include Cu, Ni, Au, Ag, Pt and Pd.

The thin film capacitor manufactured according to the invention may be applied to a PCB.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates electric properties according to application of recrystallization heat treatment, in which (a) is a graph showing electric properties according to DC voltages, and (b) is a graph showing capacitance density according to frequencies; and

FIG. 2 illustrates electric properties according to recrystallization heat treatment conditions, in which (a) is a graph showing capacitance density according to frequencies; and (b) is a graph showing leakage current characteristics according to voltages.

### DETAILED DESCRIPTION OF THE PREFERRED EMBODIMENT

The present invention will now be described more fully hereinafter with reference to the accompanying drawings.

The present invention has been made according to the result of the analysis of reasons by which a thin film capacitor has decrease in capacitance and degradation in BDV characteristics. That is, during simultaneous heat treatment of a metal foil and a dielectric layer, the metal foil is recrystallized. This causes defects in the interface between the metal foil and the dielectric layer, thereby deteriorating BDV characteristics. Furthermore, the oxidation of the metal foil results in the decrease of capacitance.

To overcome such problems associated with the recrystallization of the metal foil, a dielectric material having a low crystallization temperature may be used or a metal having a high recrystallization temperature may be used for a metal electrode. However, the former has a problem in that there are no dielectric materials known to crystallize at a temperature lower than the recrystallization temperature of metal. For the latter, some metals such as Pt and Pd are adoptable, but they are expensive.

Accordingly, the present invention has adopted recrystallization heat treatment of the metal foil.

While several problems resulting from the oxidation of the metal foil have been reported up to the present, there are no reports about the heat treatment of the metal foil in terms of recrystallization.

US Patent Application Publication No. 2002/0195612 discloses pre-heating or pre-annealing of a Cu foil prior to the formation of a dielectric layer. However, the pre-heating is not performed in terms of recrystallization. Rather, the pre-heating is performed merely in terms of preventing Cu atoms from diffusing into the dielectric layer, at a high or low temperature. In case of the low temperature, heat treatment is carried out for a long time period.

In this technology, it is presumed that a thin oxide layer restrains Cu ions from diffusion. Through experiments, the inventors have found that heat treatment when performed for a long time period inevitably results in capacitance decrease even though performed at a low temperature in an anaerobic atmosphere. Furthermore, while the Ni layer as a barrier has a thickness on the order of 0.1 μm to 2.0 μm according to this technology, experiments of the inventors have observed that the nickel layer thickness is reduced owing to volatilization during the heat treatment.

Accordingly, the inventors have adopted recrystallization heat treatment capable of preventing the oxidation of a metal foil to overcome decrease in capacitance and deterioration in BDV characteristics. Such features will be described in detail step-by-step.

According to the present invention, first, a metal foil is recrystallized via heat treated for or recrystallization heat treated. The metal foil is a substrate supporting a capacitor, acting as a lower electrode. The metal foil is preferably made of Cu or Cu alloy which is cheap and easily handled.

A barrier layer may be additionally formed on the metal foil. Such a barrier layer may be formed on one side surface or both side surfaces of the metal foil. The barrier layer functions to prevent oxidation, and adopts any types of metals which can perform such a function. Examples of the adoptable metal include Ni, in which 3% to 15% of P may be contained. The barrier layer may be formed for example via plating or deposition. For the plating, any of electrolytic plating and electroless plating can be adopted. In a case where Ni is adopted for the barrier layer, it may volatilize in the heat treatment. The Ni barrier layer may be provided preferably at a thickness of 0.8 μm or more, and more preferably, at a thickness ranging from 0.8 μm to 4 μm.

After the formation of the barrier layer, the recrystallization heat treatment is performed. Since the recrystallization heat treatment of the metal foil with or without the barrier layer is supposed to recrystallize the metal foil, this process can be performed for a short time period at a relatively lower temperature. Accordingly, even if the recrystallization heat treatment is performed in an ambient atmosphere, there is no worry about the oxidation of the metal foil.

The recrystallization heat treatment is performed preferably at a temperature ranging from 100° C. to 450° C. More preferably, the recrystallization heat treatment may be performed for a short time period at a relatively higher temperature for example in the range from 400° C. to 450° C. Performing this process for a long time period may deteriorate dielectric characteristics of capacitance owing to oxidation. Treatment time is not limited in a temperature range from 100° C. to 400° C., but set preferably in the range from 5 mins to 30 mins in a higher temperature range from 400° C. to 450° C. since oxidation may take place in this range. Recrystallization does not take place when the recrystallization heat treatment is performed at a too low temperature or for a too short time period. If the recrystallization heat treatment temperature is too high or the recrystallization heat treatment time exceeds 30 mins at a higher temperature range from 400° C. to 450° C., oxidation may take place. At a low temperature range under 400° C., oxidation would rarely take place even if the treatment time is prolonged more or less.

When the recrystallization heat treatment of the invention is performed, its atmosphere is not specifically controlled. For example, the recrystallization heat treatment may be performed in an ambient atmosphere. This is because that there is no worry about oxidation since the recrystallization heat treatment is performed at a low temperature or for a short time period at a temperature range from 400° C. to 450° C. The ambient atmosphere is easier in terms of process management than anaerobic atmosphere.

After the recrystallization heat treatment, a dielectric layer is formed on the metal foil with or without the barrier layer formed thereon. The dielectric layer may be formed via sol-gel method, spin coating or deposition. Examples of the deposition include physical vapor deposition (PVD), atomic layer deposition (ALD) and chemical vapor deposition CVD. The dielectric layer is formed preferably at a thickness in the range from 10 nm to 1,000 nm. The dielectric layer may be made of any typical dielectric material used for thin film capacitors, and preferably, of a ferroelectric material. Examples of the ferroelectric material include PZT (Pb(Zr, Ti)O₃) or PLZT ((Pb, La) (Zr, Ti)O₃), BTO (BaTiO₃) and the like.

After the dielectric layer is formed, heat treatment is performed. The heat treatment is performed at a temperature necessary for the recrystallization of the dielectric layer.

Then, an upper electrode is formed on the top surface of the crystallized dielectric thin film. The upper electrode may be made of any metal which is adoptable to thin film capacitors. Examples of the adoptable metal may include Pt, Au, Ag, Cu, Ni, Pd and the like. The upper electrode may be formed via deposition and plating alone or in combination. Examples of the deposition may include PVD, CVD and the like, and examples of the plating may include electroless plating, electrolytic plating and the like. The thickness of the upper electrode is preferably in the range from 0.1 μm to 100 μm.

The thin film capacitor manufactured according to this invention is suitable to be embedded in a PCB. The thin film capacitor of the invention may be stacked on at least one laminated layer. For example, a PCB may be fabricated by layering a polymer substrate on a copper clad laminate (CCL), stacking a thin film capacitor of the invention on the polymer substrate, and compressing the thin film capacitor against the polymer substrate. Accordingly, the thin film capacitor manufactured according to the invention can be embedded in the PCB according to a typical fabrication process of the PCB.

Hereinafter the invention will be described in more detail with reference Examples.

### EXAMPLE 1

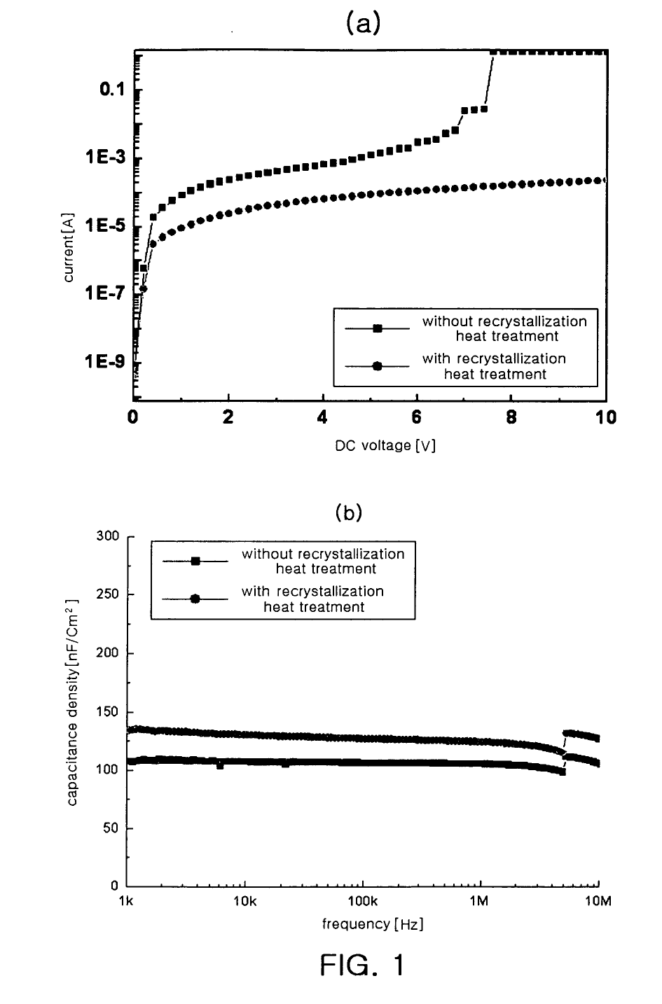

A Ni layer (containing 8% to 12% of P) was formed to a thickness of 4 μm on a Cu foil via electroless plating. The Ni-plated Cu foil was recrystallized via heat treatment (or recrystallization heat treated) at 300° C. for 10 mins in an ambient atmosphere. Then, ferroelectric sol of PZT was spin-coated at 3000 rpm for 20 secs on the top of the Ni layer to form a dielectric layer. Crystallization was performed via heat treatment at 450° C. for 10 mins and then at 550° C. for 30 mins in a nitrogen atmosphere. During the heat treatment in the nitrogen atmosphere, temperature was raised at a rate of 2° C. per min, and nitrogen gas was introduced at a rate of 5 liter per min. Au was deposited on the top of the heat-treated dielectric layer by using a DC sputterer. By using the Au deposition as an upper electrode, electric properties were measured. The electric properties measured are reported in FIG. 1.

As shown in FIG. 1(a), a conventional example without a recrystallized metal layer showed low leakage current characteristics but the leakage current increased with the voltage rising. Dielectric breakdown was observed in the range from 6V to 8V. Such dielectric breakdown indicates that a dielectric material loses its dielectric properties. On the contrary, when the recrystallization heat treatment was performed according to the invention, BDV characteristics were maintained up to 10V.

FIG. 10(b) shows capacitance density characteristics according to frequencies. It can be observed that capacitance characteristics were improved in Example 1 where the recrystallization heat treatment was performed according to the invention than the conventional example without the recrystallization heat treatment.

### EXAMPLE 2

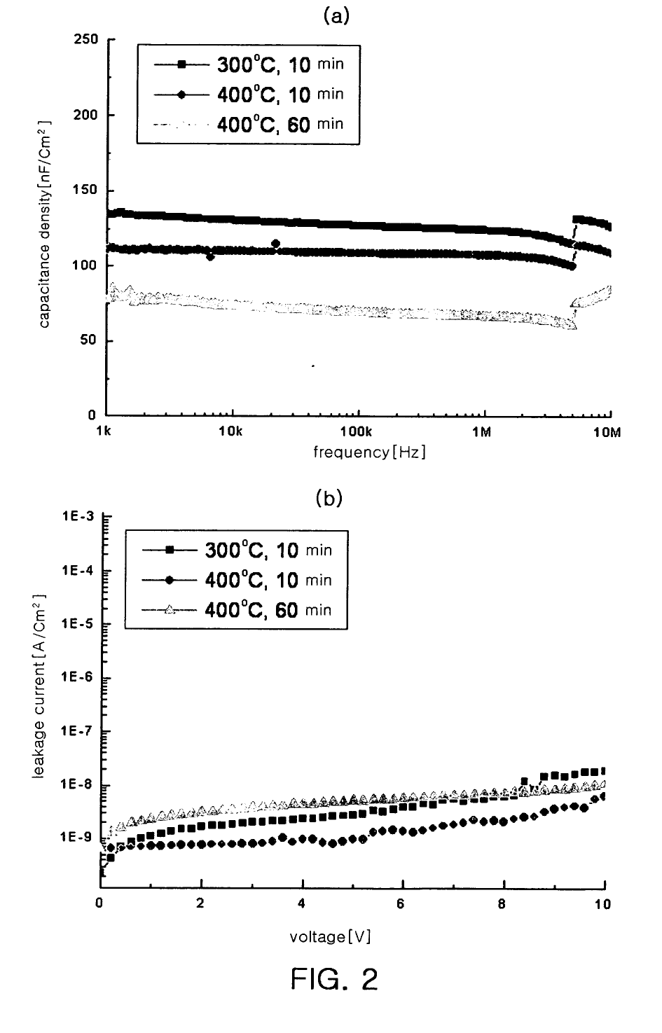

A Ni layer (containing 8% to 12% of P) was formed to a thickness of 4 μm on a Cu foil via electroless plating. The Ni-plated Cu foil was recrystallized via heat treatment (or recrystallization heat treated) in an ambient atmosphere according to conditions reported in FIG. 2.

After the recrystallization heat treatment, a ferroelectric sol of PZT was spin-coated on the Ni layer at 3000 rpm for 20 secs to form a dielectric layer. Crystallization was performed via heat treatment at 450° C. for 10 mins and then at 550° C. for 30 mins in a nitrogen atmosphere. During the heat treatment in the nitrogen atmosphere, temperature was raised at a rate of 2° C. per min, and nitrogen gas was introduced at a rate of 5 liter per min. Au was deposited on the top of the heat-treated dielectric layer by using a DC sputterer. By using the Au deposition as an upper electrode, electric properties were measured. The electric properties measured are reported in FIG. 2.

As shown in FIG. 2, capacitance characteristics were most excellent when heat treated at 300° C. for 10 mins. When heat treated at 400° C. for 60 mins, leakage current characteristics were good but capacitance characteristics were not so good.

While the present invention has been described with reference to the particular illustrative embodiments and the accompanying drawings, it is not to be limited thereto but will be defined by the appended claims. It is to be appreciated that those skilled in the art can substitute, change or modify the embodiments into various forms without departing from the scope and spirit of the present invention. For example, while Examples of the invention use PZT as a dielectric material, a ferroelectric material used for an embedded capacitor can be used either.

As set forth above, the present invention performs recrystallization heat treatment in such a manner of preventing the oxidation of a metal foil, by which a dielectric layer can be heat treated at a high temperature, thereby improving electric properties of a thin film capacitor and the reliability of a product.

What is claimed is:

1. A method of manufacturing a thin film capacitor, comprising steps of:
recrystallizing a metal foil via heat treatment;
forming a dielectric layer on a top surface of the recrystallized metal foil;
heat treating the metal foil and the dielectric layer; and
forming an upper electrode on a top surface of the heat-treated dielectric layer.

2. The method of manufacturing a thin film capacitor according to claim 1, wherein the recrystallizing step is performed at a temperature ranging from 100° C. to 400° C.

3. The method of manufacturing a thin film capacitor according to claim 1, wherein the recrystallizing step is performed at a temperature ranging from 100° C. to 450° C. for 5 mins to 30 mins.

4. The method of manufacturing a thin film capacitor according to claim 1, wherein the recrystallizing step is performed in an ambient atmosphere.

5. The method of manufacturing a thin film capacitor according to claim 1, wherein the metal foil is one selected from Cu and Cu alloys.

6. The method of manufacturing a thin film capacitor according to claim 1, further comprising a step of forming a barrier layer on a top surface of the metal foil before the recrystallizing step.

7. The method of manufacturing a thin film capacitor according to claim 6, wherein the barrier layer comprises Ni.

8. The method of manufacturing a thin film capacitor according to claim 7, wherein the Ni barrier layer has a thickness ranging from 0.8 μm to 4 μm.

9. The method of manufacturing a thin film capacitor according to claim 1, wherein the dielectric layer is one selected from PZT and PLZT.

10. The method of manufacturing a thin film capacitor according to claim 1, wherein the upper electrode comprises one selected from a group consisting of Cu, Ni, Au, Ag, Pt and Pd.

11. A method of manufacturing a thin film capacitor, comprising steps of:
recrystallizing a metal foil via heat treatment at a temperature ranging from 100° C. to 450° C. for 5 mins to 30 mins;
forming a dielectric layer on a top surface of the recrystallized metal foil;
heat treating the metal foil and the dielectric layer; and
forming an upper electrode on a top surface of the heat-treated dielectric layer.

12. The method of manufacturing a thin film capacitor according to claim 11, wherein the recrystallizing step is performed in an ambient atmosphere.

13. The method of manufacturing a thin film capacitor according to claim 11, wherein the metal foil is one selected from Cu and Cu alloys.

14. The method of manufacturing a thin film capacitor according to claim 11, further comprising a step of forming a barrier layer on a top surface of the metal foil before the recrystallizing step.

15. The method of manufacturing a thin film capacitor according to claim 14, wherein the barrier layer comprises Ni.

16. The method of manufacturing a thin film capacitor according to claim 15, wherein the Ni barrier layer has a thickness ranging from 0.8 μm to 4 μm.

17. The method of manufacturing a thin film capacitor according to claim 11, wherein the dielectric layer is one selected from PZT and PLZT.

18. The method of manufacturing a thin film capacitor according to claim 11, wherein the upper electrode comprises one selected from a group consisting of Cu, Ni, Au, Ag, Pt and Pd.

19. A thin film capacitor manufactured according to a method as defined in claim 11.

20. A printed circuit board having a thin film capacitor embedded therein, wherein the thin film capacitor according to claim 19 is layered on a polymer substrate.
